(19) United States
(12) Patent Application Publication
(10) Pub. No.: US 2026/0349391 A1
(43) Pub. Date: Nov. 5, 2026

(54) ELECTRONIC WATCH

(71) Applicant: CITIZEN WATCH CO., LTD., Nishitokyo-shi, Tokyo (JP)

(72) Inventors: Daisuke HARAGUCHI, Nishitokyo-shi, Tokyo (JP); Kazutaka IGARASHI, Nishitokyo-shi, Tokyo (JP)

(73) Assignee: CITIZEN WATCH CO., LTD., Nishitokyo-shi, Tokyo (JP)

(21) Appl. No.: 19/101,824

(22) PCT Filed: Sep. 26, 2023
(86) PCT No.: PCT/JP2023/034951

§ 371 Date: Feb. 6, 2025

(30) Foreign Application Priority Data
Oct. 27, 2022 (JP) 2022-171940

(51) Int. Cl. G04B 19/26; G04C 3/14

(52) U.S. Cl. CPC G04B 19/268; G04C 3/14

(57) ABSTRACT

A control circuit controls, with a third actuator, a moon age plate rotation direction that is a rotation direction of a moon age plate and a moon age plate rotation position that is a rotation position of the moon age plate. When determining that a switching operation between a Northern Hemisphere indication mode and a Southern Hemisphere indication mode has been performed, assuming that a moon age difference of a current moon age based on a current moon age plate rotation position with respect to a reference moon age is defined as a reference moon age difference, the control circuit rotationally drives in a step manner the moon age plate from the current moon age plate rotation position to a post-switching moon age plate rotation position separated on an opposite side to the current moon age from the reference moon age by the reference moon age difference.

### CROSS REFERENCE TO RELATED APPLICATIONS

This application is a National Stage of International Application No. PCT/JP2023/034951 filed Sep. 26, 2023, claiming priority based on Japanese Patent Application No. 2022-171940 filed Oct. 27, 2022.

### FIELD

The present invention relates to an electronic watch.

### BACKGROUND

Some watches include a time indication portion and a moon phase indication portion that indicates waxing and waning of the moon, that is, a moon phase, and provides a user with a moon phase indication corresponding to the moon age at the current date and time. The moon phase indication portion has a moon age plate opening formed in a dial plate and a moon age plate on which the moon (full moon) is indicated and that is rotationally driven, and performs the moon phase indication corresponding to the moon age by relatively rotating the moon age plate in one direction with respect to the moon age plate opening.

Here, since the state of a change in waxing and waning of the moon varies depending on the latitude at which the user is currently located, the corresponding moon phase indication of the watch also varies. Specifically, at the same date and time and the same longitude (predetermined moon age), the direction of a change in moon phase indication with the passage of date and time is different. Accordingly, the position and the rotation direction of the moon age plate with respect to the moon age plate opening are made different depending on whether the user carrying the watch is located in the Northern Hemisphere or the Southern Hemisphere. For example, when the watch moves from the Northern Hemisphere to the Southern Hemisphere, the rotation direction of the moon age plate is changed from the rotation direction for the Northern Hemisphere to the rotation direction for the Southern Hemisphere, and the moon age plate is rotated from a rotation position corresponding to the moon age for the Northern Hemisphere at the current date and time to a rotation position corresponding to the moon age for the Southern Hemisphere. As a conventional watch, a watch in which a user manually changes the rotation direction of a moon age plate is provided (see Patent Literatures 1 and 2).

### CITATION LIST

### Patent Literature

Patent Literature 1: JP 2018-155747 A

Patent Literature 2: JP 2009-216547 A

### SUMMARY

### Technical Problem

On the other hand, when the watch moves from one of the Northern Hemisphere and the Southern Hemisphere to the other, as a method of rotationally driving the moon age plate from one of the moon phase for the Northern Hemisphere and the moon phase for the Southern Hemisphere to a rotation position corresponding to the other moon phase, it is conceivable that the user manually operates the watch. However, since the user grasps the moon phase in the hemisphere to which the user has moved, that is, the post-movement hemispherical moon phase, and manually operates the watch to rotate the moon age plate to the rotation position corresponding to the post-movement hemispherical moon phase, that is, the post-movement rotation position, it is troublesome for the user, and it is preferable that the moon age plate be automatically rotated to the post-movement rotation position, and it is desirable that it is automatically performed by the electronic watch. In the electronic watch, when the moon phase indication portion is switched between a Northern Hemisphere indication mode and a Southern Hemisphere indication mode, a control circuit changes the rotation direction of the moon age plate, and rotationally drives the moon age plate to the post-movement rotation position. In an electronic watch, driving with low power consumption is desired, but when a control circuit calculates the post-movement hemispherical moon age based on the current date and time and rotationally drives the moon age plate to the post-movement rotation position corresponding to the calculated post-movement hemispherical moon age as in Patent Literature 1, because the calculation of the post-movement hemispherical moon age is complicated and the arithmetic load of the control circuit is high, there is a problem that power consumption increases when high-load processing is performed each time the indication mode is switched.

The present invention has been made in view of the above, and an object is to propose an electronic watch capable of suppressing an arithmetic load of a control circuit in a switching operation of an indication mode of a moon phase indication portion.

### Solution to Problem

In order to solve the above mentioned problem and achieve the object, an electronic watch according to the present invention includes a time indication portion that performs time indication based on an internal time; a moon phase indication portion that includes at least a moon age plate rotatably supported and performs moon phase indication corresponding to a moon age by rotation of the moon age plate; an actuator for the moon age plate that rotationally drives the moon age plate; a control circuit that controls a moon age plate rotation direction that is a rotation direction of the moon age plate and a moon age plate rotation position that is a rotation position of the moon age plate with the actuator for the moon age plate; and an operation portion that at least switches an indication mode of the moon phase indication portion to one of a Northern Hemisphere indication mode that indicates a moon phase in a Northern Hemisphere and a Southern Hemisphere indication mode that indicates a moon phase in a Southern Hemisphere, wherein the control circuit when it is determined that an operation of switching the indication mode is performed by the operation portion, when a moon age difference of a current moon age based on a current moon age plate rotation position with respect to a reference moon age is defined as a reference moon age difference, rotationally drives the moon age plate with the actuator for the moon age plate from the current moon age plate rotation position to a post-switching moon age plate rotation position separated by the reference moon age difference on an opposite side to a current moon age side from the reference moon age, and sets the moon age plate rotation direction to a post-switching moon age plate rotation direction that is an opposite direction to a current moon age plate rotation direction.

### Advantageous Effects of Invention

The electronic watch according to the present invention has an effect of being able to suppress the arithmetic load of the control circuit in the switching operation of the indication mode of the moon phase indication portion.

### BRIEF DESCRIPTION OF DRAWINGS

FIG. 1 is an overall configuration diagram of an electronic watch according to an embodiment.

FIG. 2 is an operation explanatory diagram (Northern Hemisphere indication mode) of a moon phase indication portion of the electronic watch according to the embodiment.

FIG. 3 is an operation explanatory diagram (Southern Hemisphere indication mode) of the moon phase indication portion of the electronic watch according to the embodiment.

FIG. 4 is a block diagram of a movement of the electronic watch according to the embodiment.

FIG. 5 is an operation explanatory diagram of a function indication portion at the time of an indication mode switching operation.

FIG. 6 is an operation explanatory diagram of the function indication portion at the time of the indication mode switching operation.

FIG. 7 is a diagram illustrating an example of operation explanation of a moon phase indication portion at the time of the indication mode switching operation.

FIG. 8 is a diagram illustrating an example of operation explanation of the moon phase indication portion at the time of the indication mode switching operation.

FIG. 9 is a flowchart of the indication mode switching operation of the electronic watch according to the embodiment.

FIG. 10 is a diagram illustrating an example of operation explanation of a moon phase indication portion at the time of an indication mode switching operation according to a modification.

FIG. 11 is a diagram illustrating an example of operation explanation of the moon phase indication portion at the time of the indication mode switching operation according to the modification.

### DESCRIPTION OF EMBODIMENT

Hereinafter, the present invention will be described in detail with reference to the drawings. Note that the present invention is not limited by the embodiment described below. In addition, constituent elements in the embodiment described below include those that can be easily assumed by those skilled in the art or those that are substantially the same.

### Embodiment

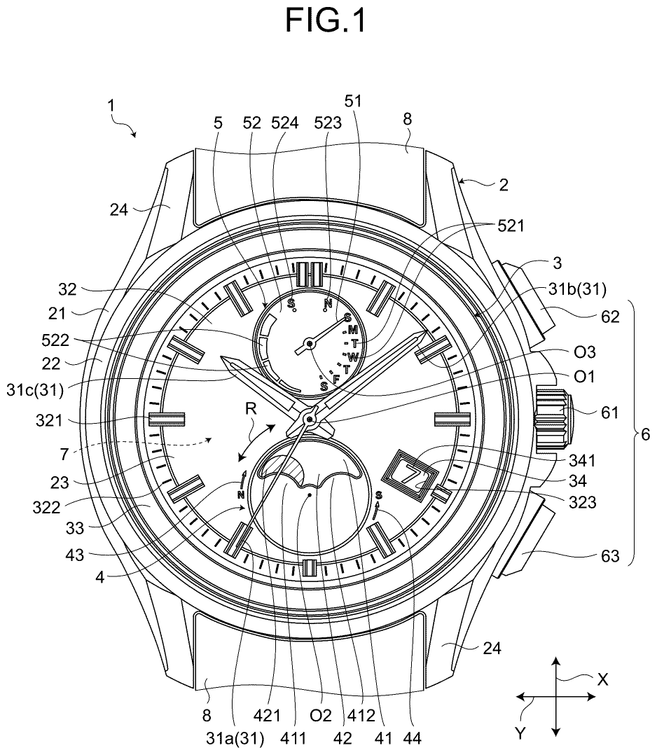

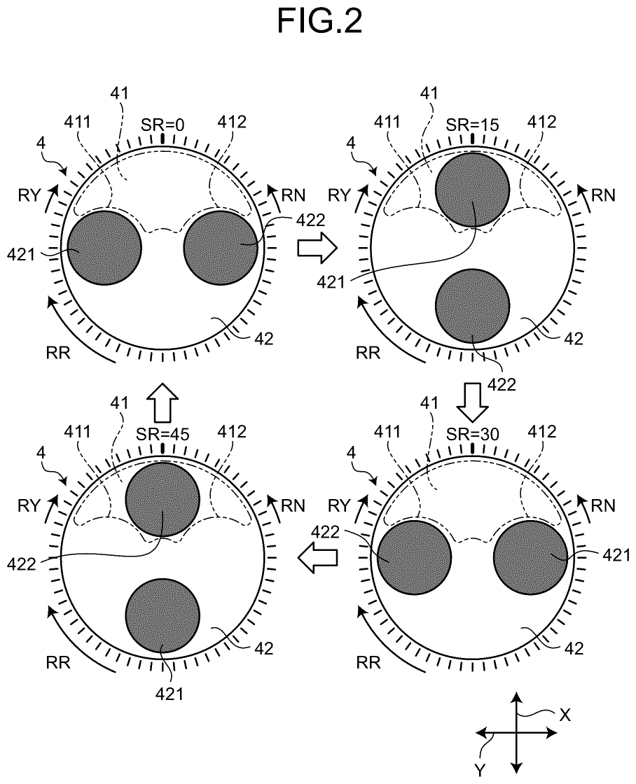

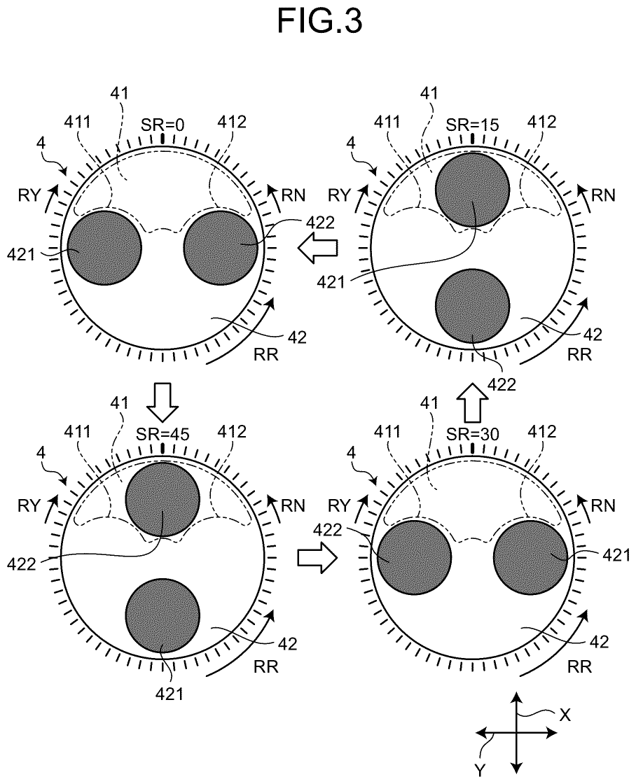

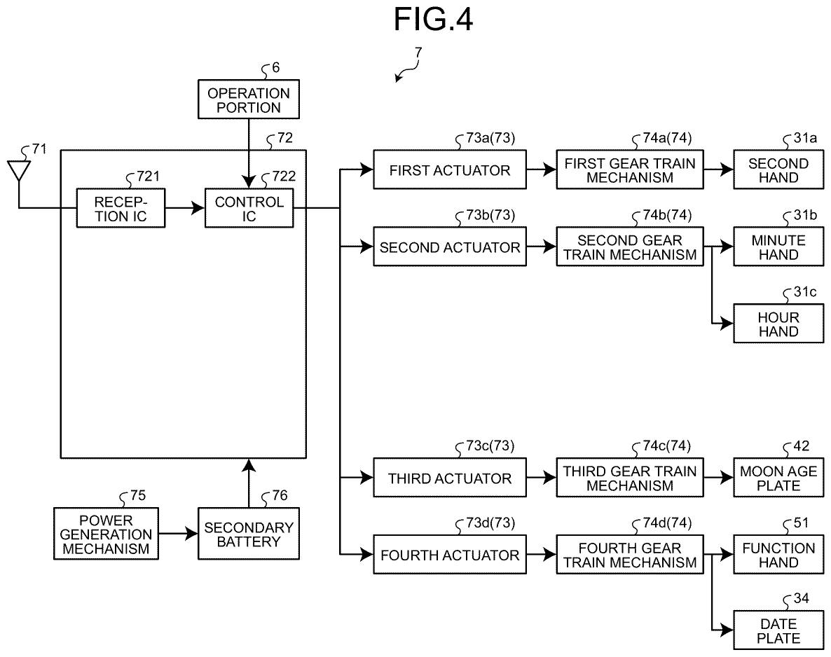

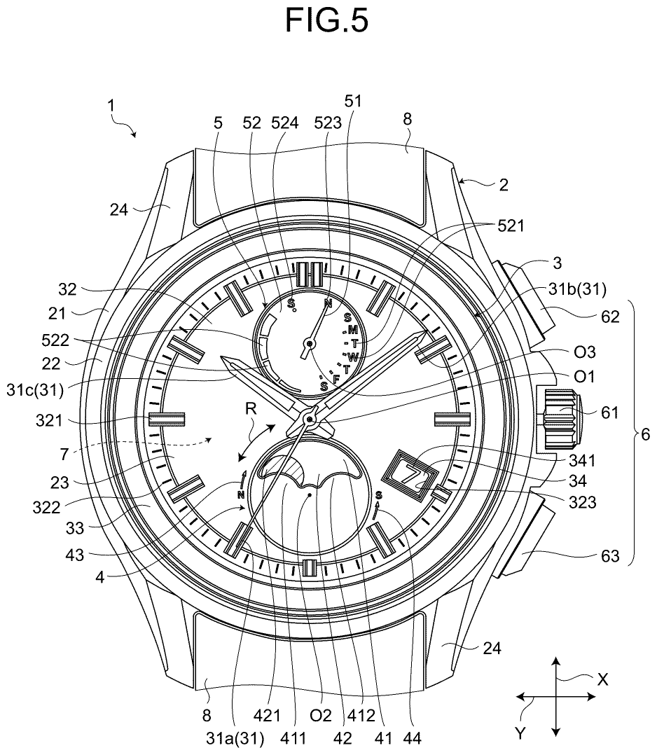

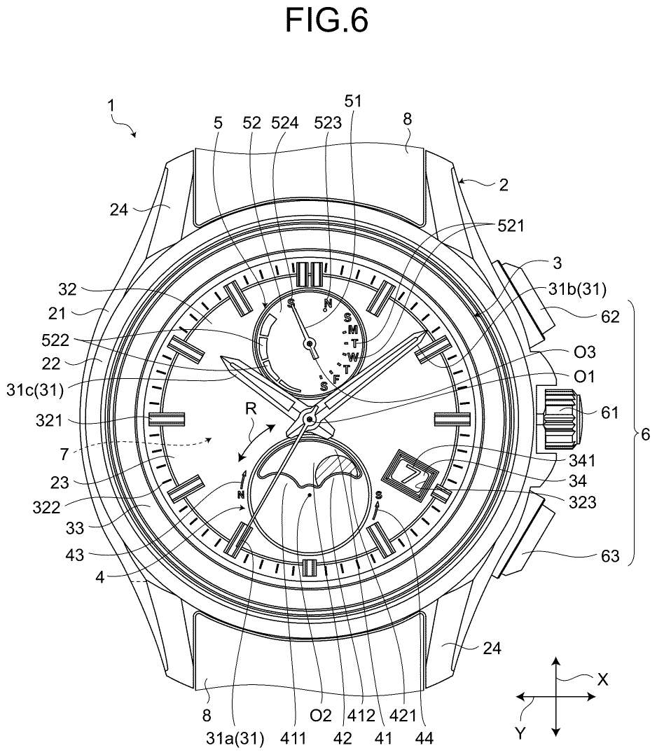

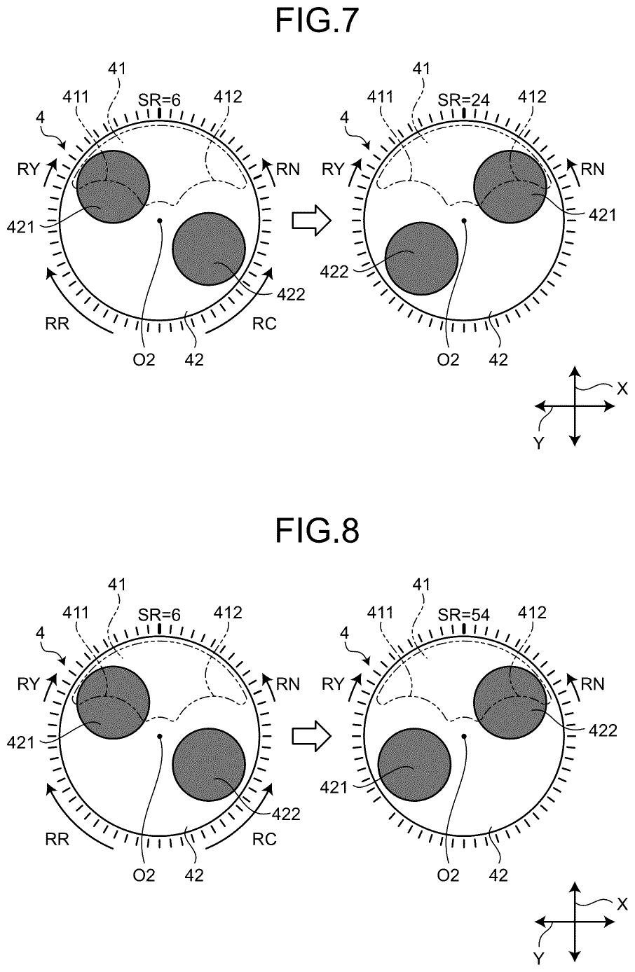

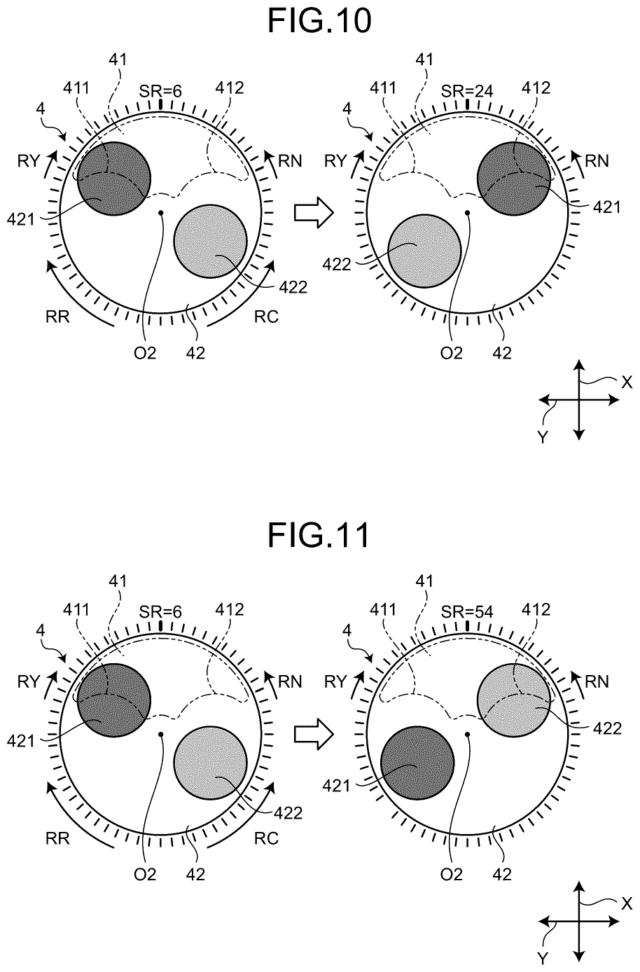

FIG. 1 is an overall configuration diagram of an electronic watch according to an embodiment. FIG. 2 is an operation explanatory diagram (Northern Hemisphere indication mode) of the moon phase indication portion of the electronic watch according to the embodiment. FIG. 3 is an operation explanatory diagram (Southern Hemisphere indication mode) of the moon phase indication portion of the electronic watch according to the embodiment. FIG. 4 is a block diagram of a movement of the electronic watch according to the embodiment. FIG. 5 is an operation explanatory diagram of a function indication portion at the time of an indication mode switching operation. FIG. 6 is an operation explanatory diagram of the function indication portion at the time of the indication mode switching operation. FIG. 7 is a diagram illustrating an example of operation explanation of a moon phase indication portion at the time of the indication mode switching operation. FIG. 8 is a diagram illustrating an example of operation explanation of the moon phase indication portion at the time of the indication mode switching operation. In addition, an X direction in FIGS. 1 to 3 and FIGS. 5 to 8 (including FIGS. 10 and 11) is a 12 o'clock-6 o'clock direction of the electronic clock, a Y direction is a 3 o'clock-9 o'clock direction of the electronic watch, and a direction orthogonal to the X direction and the Y direction is an up-down direction (thickness direction) of the electronic watch. O1 is the center of an electronic watch 1 and coincides with the rotation axis of a pointer. In addition, a direction on the XY plane about O1 is referred to as a radial direction.

The electronic watch 1 according to the embodiment is an electronic watch that clocks an internal time based on an output of a quartz crystal oscillator and indicates the clocked time with a pointer 31. The electronic watch 1 may be a multifunctional electronic watch having an alarm function, a chronograph function, or the like in addition to clocking. Further, it may be a terminal device interlocking watch that is connected to an external terminal device by a communication unit by at least one of wireless or wired and achieves a specific function (for example, an alarm function, a time correction function based on internal time information of the terminal device, a notification function of performing notification at the time of mail reception, and the like) based on a request set in the terminal device.

As illustrated in FIG. 1, the electronic watch 1 includes an exterior case 2, a time indication portion 3, a moon phase indication portion 4, a function indication portion 5, an operation portion 6, and a movement 7. In the electronic watch 1 in the present embodiment, the time indication portion 3 is an analog electronic wristwatch of an analog indication type, and the moon phase indication portion 4 is a moonphase watch that indicates the waxing and waning of the moon, that is, the moon phase. Although the electronic watch 1 is described as of a wristwatch type, the electronic watch 1 may be of another watch type, for example, a pocket watch, as long as the electronic watch 1 has a function as a moonphase watch.

The exterior case 2 constitutes the outermost frame of the electronic watch 1, and includes a body 21, a bezel 22, a windshield 23, and a back lid, which is not illustrated. The body 21 has an opening, and the time indication portion 3, the moon phase indication portion 4, the function indication portion 5, and the movement 7 are held in an internal space portion S1 corresponding to a space inside the opening. In the present embodiment, the body 21 has an annular shape, and the opening has a circular shape centered on the watch center O1 of the electronic watch 1. The shape of the opening can be any shape according to the outer shape or design of the exterior case 2 of the electronic watch 1. The body 21 includes end pieces 24 formed so as to protrude from outer peripheral side surfaces from the 12 o'clock direction and the 6 o'clock direction. One end of a belt 8 is coupled to the end piece 24 on the 12 o'clock side, and the other end of the belt 8 is coupled to the end piece 24 on the 6 o'clock side.

The windshield 23 covers an upward opening on one side of the opening of the body 21, and the back lid covers a downward opening on the other side, and they are fixed, so that the internal space portion S1 becomes a closed space, and thus the time indication portion 3, the moon phase indication portion 4, the function indication portion 5, and the movement 7 can be protected. When the windshield 23 and the back lid are fixed to the body 21, by interposing a waterproof member, which is not illustrated, such as a rubber packing, the holding force can be increased, and the dustproofness and waterproofness of the electronic watch 1 can be enhanced. The body 21 is formed of, for example, a resin material, a metal material, a ceramic material, or the like. The bezel 22 is to fix the windshield 23 to the body 21, and is formed in an annular shape and fixed to an annular portion of the body 21 constituting the internal space portion S1. The bezel 22 is located radially outside the time indication portion 3. The bezel 22 is formed of, for example, a resin material, a metal material, a ceramic material, or the like. Note that the bezel 22 may be rotatably supported with respect to the body 21 about the watch center O1 of the electronic watch 1. The windshield 23 has a shape that covers the opening on the upward direction side via the bezel 22, and is inserted from the upward direction side and fixed to the bezel 22 and is fixed to the body 21 via the bezel 22 so as to close the internal space portion S1. In the present embodiment, the outer shape of the windshield 23 in plan view is circular. The windshield 23 is formed of, for example, glass or a transparent resin material, or the like. The back lid has an engagement portion having substantially the same shape as the downward opening portion, and closes the internal space portion S1 by being inserted from the downward direction side and fixed to the body 21. In the present embodiment, the outer shape of the back lid is a circular shape. The back lid is formed of, for example, a resin material, a metal material, a ceramic material, or the like, similarly to the body 21. Note that the bezel 22 may be formed integrally with the body 21 as long as the bezel does not rotate.

The time indication portion 3 indicates the time based on the internal time. The time indication portion 3 includes the pointer 31, a dial plate 32, a dial trim ring 33, and a date plate 34. The time indication portion 3 in the present embodiment indicates an internal time (at least date information, hour information, minute information, and second information) clocked by a control circuit 72, which will be described below, of the movement 7, that is, indicates time.

The pointer 31 is rotatably supported by the movement 7 about the rotation axis being the watch center O1 of the electronic watch 1, and is rotationally driven by the movement 7. The pointer 31 has a rod shape and is formed of a metal material, a resin material, or the like. In the present embodiment, the pointer 31 is a second hand 31a, a minute hand 31b, and an hour hand 31c, and is disposed on the upward direction side (windshield 23 side) with respect to the dial plate 32. The pointer 31 is also rotated by operation of the operation portion 6 by the user. The pointer 31 can indicate the time based on the internal time according to the pointing position.

The dial plate 32 is disposed between the pointer 31 and the movement 7 to protect the movement 7. The dial plate 32 has a function of giving an aesthetic appearance of the electronic watch 1 to the user. On the surface of the dial plate 32 (the side facing the windshield 23), hour marks 321 and 322 are provided. That is, the hour marks 321 and 322 are disposed so as to face the windshield 23 in the up-down direction, and can be visually recognized by the user through windshield 23. The user can recognize the current time based on the time indication from the relative position between the pointer 31 (second hand 31a, minute hand 31b, and hour hand 31c) and the hour marks 321 and 322. The dial plate 32 is formed with a date plate opening 323 that causes the user to visually recognize the date plate 34 through the windshield 23. The date plate opening 323 is formed at a position facing the date plate 34 in the up-down direction of the dial plate 32, and penetrates the dial plate 32 up and down. The date plate opening 323 in the present embodiment has a rectangular shape and is formed at the position of “4 o'clock” on the dial plate 32.

The dial trim ring 33 is disposed on the radially outside the dial plate 32. The dial trim ring 33 is formed in an annular shape and is disposed radially outside the tip of the pointer 31. Note that the time indication portion 3 can indicate information such as setting information corresponding to a function different from the time indication function. Examples of the information indication include setting of ON/OFF of the alarm function, alarm setting time, chronograph indication, time zone indication, indication related to reception operation, and summer time setting indication. In this case, the dial plate 32 and the dial trim ring 33 are provided with a function mark, which is not illustrated, and setting information or the like of each function based on the information indication can be recognized from the relative position between the pointer 31 (second hand 31a, minute hand 31b, and hour hand 31c) and the function mark.

The date plate 34 rotates to indicate date. The date plate 34 is formed in a circular shape when viewed from the up-down direction, and is disposed between the dial plate 32 and the movement 7 in the up-down direction. The date plate 34 is rotatably supported with respect to the movement 7 about the rotation axis being the watch center O1, and is rotationally driven by the movement 7. The date plate 34 is provided with a plurality of date marks 341. The date mark 341 is visually recognized by the user through the date plate opening 323 and the windshield 23 to indicate the current date based on the internal time. The date mark 341 in the present embodiment is a number “1” to “31” corresponding to a date, and is formed clockwise in a region of one turn in the circumferential direction on the date plate 34.

As illustrated in FIGS. 1 to 3, the moon phase indication portion 4 performs the moon phase indication corresponding to the moon age by the rotation of a moon age plate 42. The moon phase indication portion 4 includes a moon age plate opening 41, the moon age plate 42, and moon age plate rotation direction marks 43 and 44.

The moon age plate opening 41 causes the user to visually recognize the moon age plate 42 through the windshield 23. The moon age plate opening 41 in the present embodiment is formed in the dial plate 32. The moon age plate opening 41 faces the moon age plate 42 in the up-down direction, and the dial plate 32 is formed in a substantially fan shape in the 12 o'clock direction in the region facing the moon age plate 42. Recesses 411 and 412 are formed at both ends of the moon age plate opening 41 in a moon age plate rotation direction R. The recesses 411 and 412 indicate the waxing and waning of the moon when overlapped with moon marks 421 and 422, which will be described below, of the moon age plate 42 in the up-down direction. Here, the moon age plate rotation direction R is a direction around a moon age plate center O2 of the moon age plate 42, and has two rotation directions: a current moon age plate rotation direction RR and a post-switching moon age plate rotation direction RC opposite to the current moon age plate rotation direction RR. Note that, in FIGS. 2 and 3, the moon age plate opening 41 (including the recesses 411 and 412) are illustrated by dotted lines for the sake of easy understanding of the operation of the moon marks 421 and 422 illustrated.

The moon age plate 42 rotates to perform moon phase indication corresponding to the moon age. The moon age plate 42 is formed in a circular shape when viewed from the up-down direction, and is disposed between the dial plate 32 and the movement 7 in the up-down direction. The moon age plate 42 is rotatably supported with respect to the movement 7 about the rotation axis being the moon age plate center O2 of the moon age plate 42, and is rotationally driven by the movement 7. Here, in the moon age plate 42, the clockwise rotation is the forward rotation, the counterclockwise rotation is the reverse rotation, the clockwise direction is the forward rotation direction RY, and the counterclockwise direction is the reverse rotation direction RN. In the moon age plate 42, the two moon marks 421 and 422 are formed on an opposing surface facing the dial plate 32 among both surfaces in the up-down direction. The moon marks 421 and 422 are formed so as to face each other across the moon age plate center O2, that is, so as to be spaced apart 180 degrees in the moon age plate rotation direction R. That is, the moon phase indication portion 4 in the present embodiment performs the moon phase indication corresponding to the moon age of the synodic period of two synodic periods in one rotation. The moon marks 421 and 422 in the present embodiment are the same (same shape, same color, and the like) and cannot be distinguished even when the user visually recognizes the moon marks 421 and 422. For example, when the electronic watch 1 is in a Northern Hemisphere indication mode DN described below, the forward rotation direction RY of the moon age plate 42 is the current moon age plate rotation direction RR. When the current moon age plate rotation direction RR is the forward rotation direction RY, as illustrated in FIG. 2, the moon age plate 42 makes one rotation to sequentially perform the moon phase indication (the moon age plate 42 in the upper left of the figure) of the new moon (moon age=0) in the first synodic period corresponding to the moon mark 421, the moon phase indication (the moon age plate 42 in the upper right of the figure) of the full moon (moon age=15) in the first synodic period corresponding to the moon mark 421, the moon phase indication (the moon age plate 42 in the lower right of the drawing; corresponding to the position of the moon mark 421 that is the moon phase indication of the new moon in the first synodic period) of the new moon (moon age=0) in the second synodic period corresponding to the moon mark 422, the moon phase indication (the moon age plate 42 in the lower left of the figure) of the full moon (moon age=15) in the second synodic period corresponding to the moon mark 422, and the moon phase indication (corresponding to the position of the moon mark 422 that is the moon phase indication of the new moon in the second synodic period) of the new moon in the first synodic period corresponding to the moon mark 421. On the other hand, when the electronic watch 1 is in a Southern Hemisphere indication mode DS described below, the reverse rotation direction RN of the moon age plate 42 is the current moon age plate rotation direction RR. When the current moon age plate rotation direction RR is the reverse rotation direction RN, as illustrated in FIG. 3, the moon age plate 42 makes one rotation to sequentially perform the moon phase indication (the moon age plate 42 in the upper left of the figure) of the new moon (moon age=0) in the second synodic period corresponding to the moon mark 422, the moon phase indication (the moon age plate 42 in the lower left of the figure) of the full moon (moon age=15) in the second synodic period corresponding to the moon mark 422, the moon phase indication (the moon age plate 42 in the lower right of the drawing; corresponding to the position of the moon mark 422 that is the moon phase indication of the new moon in the second synodic period) of the new moon (moon age=0) in the first synodic period corresponding to the moon mark 421, the moon phase indication (the moon age plate 42 in the upper right of the figure) of the full moon (moon age=15) in the first synodic period corresponding to the moon mark 421, and the moon phase indication (corresponding to the position of the moon mark 421 that is the moon phase indication of the new moon in the first synodic period) of the new moon in the second synodic period corresponding to the moon mark 422.

The moon age plate rotation direction marks 43 and 44 indicate the moon age plate rotation direction R in each indication mode D. The moon age plate rotation direction marks 43 and 44 are provided on the surface of the dial plate 32. The moon age plate rotation direction mark 43 corresponds to the Northern Hemisphere indication mode DN, and includes a clockwise arrow figure and an abbreviated alphabetic character “N” corresponding to the north. The moon age plate rotation direction mark 44 corresponds to the Southern Hemisphere indication mode DS, and includes a counterclockwise arrow figure and an abbreviated alphabetic character “S” corresponding to the south.

The function indication portion 5 indicates the state of the electronic watch 1 based on a function different from the time indication function of the electronic watch 1, that is, indicates the function. The function indication portion 5 includes a function hand 51 and a function mark plate 52. The function indication portion 5 in the present embodiment indicates the current day of the week based on the internal time clocked by the control circuit 72, that is, indicates the day of the week, indicates the remaining level of a secondary battery 76 measured by the control circuit 72, that is, indicates the remaining level, and indicates the indication mode D of the moon phase indication portion 4 that is one of the Northern Hemisphere indication mode DN and the Southern Hemisphere indication mode DS stored in the control circuit 72, that is, indicates the indication mode.

The function hand 51 is rotatably supported by the movement 7 about the rotation axis being a function mark center O3 of the function mark plate 52, and is rotationally driven by the movement 7. The function hand 51 has a rod shape and is formed of a metal material, a resin material, or the like. In the present embodiment, the function hand 51 is disposed on the upward direction side (windshield 23 side) with respect to the function mark plate 52. The function hand 51 is rotated by the operation of the operation portion 6 by the user, that is, instructs any one of the above-described function indications. The function hand 51 can indicate the function based on each function according to the pointing position.

The function mark plate 52 is disposed between the function hand 51 and the movement 7. The function mark plate 52 in the present embodiment is formed as a part of the dial plate 32. A day-of-week mark, a remaining level mark 522, a Northern Hemisphere indication mode mark 523, and a Southern Hemisphere indication mode mark 524 are provided on the surface (the side facing the windshield 23) of the function mark plate 52. That is, the function marks 521 to 524 are disposed so as to face the windshield 23 in the up-down direction, and can be visually recognized by the user through windshield 23. The user can recognize the state of the electronic watch 1 based on the function indication based on the relative position between the function hand 51 and the function marks 521 to 524. The day-of-week mark 521 indicates the current day of the week based on the position of the function hand 51. The day-of-week mark 521 in the present embodiment is an abbreviated alphabetic character “S”, “M”, “T”, “W”, “T”, “F”, or “S” corresponding to each day of the week (from Sunday to Saturday), and is formed clockwise in a region from the 2 o'clock direction to the 5 o'clock direction in the function mark plate 52. The remaining level mark 522 indicates the remaining level of the secondary battery 76 based on the position of the function hand 51. The remaining level mark 522 in the present embodiment is a first remaining level figure, a second remaining level figure narrower in width in the radial direction than the first remaining level figure, a third remaining level figure narrower in width in the radial direction than the second remaining level figure, and a fourth remaining level figure narrower in width in the radial direction than the third remaining level figure, which are figures corresponding to the remaining levels, and is formed counterclockwise in a region from the 10 o'clock direction to the 6 o'clock direction in the function mark plate 52. The indication mode marks 523 and 524 corresponds to the indication mode D, and indicate a current indication mode DR based on the position of the function hand 51. The Northern Hemisphere indication mode mark 523 in the present embodiment is an abbreviated alphabetic character “N” corresponding to the north, and is formed in a region of the 1 o'clock direction in the function mark plate 52. The Southern Hemisphere indication mode mark 524 in the present embodiment is an abbreviated alphabetic character “S” corresponding to the south, and is formed in a region of the 11 o'clock direction in the function mark plate 52. Note that the function mark plate 52 is formed as a part of the dial plate 32, but is not limited thereto, and may be formed of a plate material different from the dial plate 32. In this case, an opening for the function mark plate, which is not illustrated, is formed in the dial plate 32, and the function mark plate 52 is disposed between the dial plate 32 and the movement 7 in the up-down direction.

The operation portion 6 implements a functional operation based on the operation on the movement 7 by being operated by the user. The operation portion 6 in the present embodiment performs an operation for switching the indication mode D of the moon phase indication portion 4 from one of the Northern Hemisphere indication mode DN and the Southern Hemisphere indication mode DS to the other in the control circuit 72, that is, an indication mode switching operation. Specifically, the electronic watch 1 switches the indication mode D by the operation of the operation portion 6 by the user, that is, the indication mode switching operation, the rotation position of the moon age plate 42 of the moon phase indication portion 4, that is, the step position in the present embodiment is changed, the subsequent moon age plate rotation direction R is set to the post-switching moon age plate rotation direction RC, which is the opposite direction, from the current moon age plate rotation direction RR, and the indication mode switching operation is performed such that the function hand 51 of the function indication portion 5 points the indication mode marks 523 and 524 corresponding to the switched indication mode D. The operation portion 6 includes a crown 61, a push button 62, and a push button 63. The crown 61 is formed so as to protrude from the side surface of the body 21, and can be pulled out in one or a plurality of stages in the protruding direction by the operation of the user, and can rotate about the axis. The crown 61 is rotated in a state of being in a stage different from the 0th stage in which it is not pulled out in the protruding direction, for example, in a state of the second stage, so that the pointer 31 in the time indication state can be forcibly rotated, and the time indication can be corrected. The push buttons 62 and 63 are formed so as to protrude from the side surface of the body 21, and can be pressed in a direction opposite to the protruding direction by the operation of the user. The push buttons 62 and 63 maintain the state of protruding in the protruding direction in a state where no external force is applied. The push buttons 62 and 63 can switch between the day-of-week indication and remaining level indication on the function indication portion 5 when, for example one or both of them are pressed. The operation portion 6 is connected to the control circuit 72 of the movement 7, and outputs an operation state by the user to the control circuit 72 as an operation signal.

As illustrated in FIG. 4, the movement 7 includes an antenna 71, the control circuit 72, an actuator 73, a gear train mechanism 74, a power generation mechanism 75, the secondary battery 76, and the like, and performs the clocking function, other function operations, and the like of the electronic watch 1.

The antenna 71 receives a standard radio wave. That is, the electronic watch 1 is also a radio watch. The antenna 71 is electrically connected to the control circuit 72, and a signal of a standard radio wave is output to the control circuit 72. Note that the antenna 71 may receive a global positioning system (GPS) signal output from a satellite.

The control circuit 72 controls rotation positions and rotation directions of the pointer 31, the date plate 34, the moon age plate 42, and the function hand 51. The control circuit 72 is a circuit that controls the electronic watch 1, clocks the internal time of the electronic watch 1 based on a clock signal output from an oscillator, which is not illustrated, and outputs a control signal corresponding to each function. The control circuit 72 includes a reception IC 721 and a control IC 722 including a central processing unit (CPU) and a storage unit such as random access memory (RAM) and read only memory (ROM). The reception IC 721 performs signal processing on the standard radio wave received by the antenna 71, and outputs time information (including date information, hour information, minute information, and second information) based on the standard radio wave to the control IC 722. The control IC 722 outputs a control signal for causing the pointer 31 to indicate time to the actuator 73 based on the internal time being clocked. The control IC 722 also corrects the internal time based on the time information output from the reception IC 721. Note that the oscillator is a vibration source for generating a reference frequency related to clocking of the indication time of the electronic watch 1 and the other functional operations, and for example, a quartz crystal vibrator can be used. A temperature-compensating quartz crystal oscillator (TCXO) may be used because an oscillation characteristic of the quartz crystal vibrator easily varies depending on an external temperature.

Based on the current indication mode DR, which is one of the Northern Hemisphere indication mode DN and the Southern Hemisphere indication mode DS, the control circuit 72 also controls the moon age plate rotation direction R, which is the rotation direction of the moon age plate 42, and the moon age plate rotation position, which is the rotation position of the moon age plate 42, with a third actuator 73c, which will be described below, which is an actuator for the moon age plate. Here, the Northern Hemisphere indication mode DN is a mode for controlling the moon phase indication portion 4 to perform the moon phase indication corresponding to the moon age for the Northern Hemisphere, and rotationally drives the moon age plate 42 in one of the moon age plate rotation directions R, that is, the forward rotation direction RY in the present embodiment. The Southern Hemisphere indication mode DS is a mode for controlling the moon phase indication portion 4 to perform the moon phase indication corresponding to the moon age for the Southern Hemisphere, and rotationally drives the moon age plate 42 in the other of the moon age plate rotation directions R, that is, the reverse rotation direction RN in the present embodiment. Note that the moon ages for the Northern Hemisphere and the Southern Hemisphere on the same date and time and at the same longitude are the same moon age, but the moon phase indication corresponding to the moon phase for the Northern Hemisphere and the moon phase indication corresponding to the moon phase for the Southern Hemisphere are different. Since the control circuit 72 in the present embodiment performs step rotation driving in rotationally driving the moon age plate 42, the moon age plate rotation position is a moon age plate step position S. That is, the moon age plate 42 makes one rotation by being rotationally driven in a step manner a plurality of times by the third actuator 73c. The moon age plate 42 in the present embodiment makes one rotation in 60 steps, and performs the moon phase indication corresponding to the moon age of the synodic period of the two synodic periods, so that one synodic period is 30 steps. For example, as illustrated in FIGS. 2 and 3, assuming that the step position in the 12 o'clock direction is a current moon age plate step position SR, and that the current moon age plate step position SR in the moon phase indication of the new moon (moon age M=0) in the first synodic period corresponding to the moon mark 421 is 0 (SR=0), the moon age plate 42 sets the current moon age plate step position S in the moon phase indication of the full month (M=15) in the first synodic period corresponding to the moon mark 421 to 15 (SR=15), sets the current moon age plate step position SR in the moon phase indication of the new month (M=0) in the second synodic period corresponding to the moon mark 422 to 30 (SR=30), and sets the current moon age plate step position SR in the moon phase indication of the full moon (M=15) in the second synodic period corresponding to the moon mark 422 is 45 (SR=45).

When the date is changed based on the internal time, the control circuit 72 rotationally drives the moon age plate 42 with the third actuator 73c one step, that is, rotationally drives the moon age plate 42 one step per day, and the one step is the amount of the operation of the moon age plate 42 per day. In addition, the control circuit 72 rotationally drives the moon age plate 42 with the third actuator 73c in a step manner two steps once every 59 days instead of one step per day.

The control circuit 72 determines whether or not a mode switching operation that is a switching operation of the indication mode D is performed by the operation portion 6. The control circuit 72 in the present embodiment determines whether or not the push button 63 has been pressed in a state where the crown 61 is in a first-stage position, thereby determining whether or not the mode switching operation has been performed. When the crown 61 is in the first-stage position, the control circuit 72 rotationally drives the function hand 51 with a fourth actuator 73d to a position radially facing the indication mode marks 523 and 524 corresponding to the current indication mode DR. For example, when the current indication mode DR is the Northern Hemisphere indication mode DN, the control circuit 72 rotationally drives in a step manner the function hand 51 to a position facing the Northern Hemisphere indication mode mark 523 in the radial direction as illustrated in FIG. 5. When the mode switching operation is performed, the control circuit 72 changes the current indication mode DR to a post-switching indication mode DC. For example, when the mode switching operation is performed while the current indication mode DR is the Northern Hemisphere indication mode DN, the post-switching indication mode DC becomes the Southern Hemisphere indication mode DS, and therefore, the control circuit 72 rotationally drives in a step manner the function hand 51 to a position facing the Southern Hemisphere indication mode mark 524 in the radial direction as illustrated in FIG. 6.

When the mode switching operation is performed, the control circuit 72 rotationally drives in a step manner the moon age plate 42 with the third actuator 73c, in a case where a moon age difference of a current moon age MR based on the current moon age plate step position SR corresponding to a current moon age plate rotation position corresponding to a reference moon age MB is a reference moon age difference MD, to the post-switching moon age plate step position SC corresponding to the post-switching moon age plate rotation position corresponding to the post-switching moon age MC, which is separated on the opposite side to the current moon age MR side from the reference moon age MB by the reference moon age difference MD. In addition, when the mode switching operation is performed, the control circuit 72 sets the moon age plate rotation direction R to the post-switching moon age plate rotation direction RC that is the opposite direction to the current moon age plate rotation direction RR. Here, the reference moon age MB corresponds to the moon phase indication of the full moon, and is the center of the one synodic period, that is, half the moon age number of the one synodic period. In addition, when the moon phase indication portion 4 performs the moon phase indication corresponding to the moon age of the two synodic periods in one rotation of the moon age plate 42, the reference moon age MB refers to the reference moon age corresponding to the synodic period in the current moon age MR. Since the entire moon age number of the one synodic period in the present embodiment is 30, moon age=0 to moon age=29, the reference moon age MB is set to 15. For example, as illustrated in FIG. 7, when the mode switching operation is performed while the current moon age plate step position SR of the moon age plate 42 is 6 (SR=6) and the corresponding current moon age MR is 6 (MR=6), a reference moon age difference MDB (=|MB−MR|) , which is the moon age difference of the current moon age MR with respect to the reference moon age MB, becomes 9 (MD=9). In this case, the post-switching moon age MC that is separated by 9 moon ages, which is the reference moon age difference MDB, on the opposite side (right side in the drawing) to the current moon age MR side (left side of the moon indication of the dotted line in the drawing) from the reference moon age MB is 24 (MC=24). Note that assuming that the moon age number of the one synodic period is MA, the post-switching moon age MC can be obtained by MA−MR. Here, in the moon age plate 42 in the present embodiment, the number of the post-switching moon age plate step positions SC corresponding to the post-switching moon age MC is the number of synodic periods, i.e., two. This is because the moon age plate 42 can indicate the moon phase of the synodic period of the two synodic periods. Specifically, as illustrated in FIG. 7, a first post-switching moon age plate step position SC1, which is the post-switching moon age plate step position SC in the current moon age plate rotation direction RR with respect to the current moon age plate step position SR, and, as illustrated in FIG. 8, a second post-switching moon age plate step position SC2, which is the post-switching moon age plate step position SC in the post-switching moon age plate rotation direction RC with respect to the current moon age plate step position SR. For example, the post-switching moon age plate step position SC corresponding to the post-switching moon age MC (=24) with respect to the current moon age MR (=6) corresponding to the current moon age plate step position SR (=6, the moon phase indication is performed with the moon mark 421) includes the first post-switching moon age plate step position SC1 (=24, the moon phase indication is performed with the moon mark 421) as illustrated in FIG. 7 and the second post-switching moon age plate step position SC2 (=54, the moon phase indication is performed with the moon mark 422) as illustrated in FIG. 8. Note that assuming that the number of steps of the moon age plate 42 corresponding to the moon age number of one synodic period is SA1, the first post-switching moon age plate step position SC1 can be obtained by SA1−SR. In addition, assuming that the number of steps of the moon age plate 42 corresponding to the moon age number of two synodic periods is SA2, the second post-switching moon age plate step position SC2 can be obtained by SA2−SR. In addition, a current direction step difference SDR between the current moon age plate step position SR and the first post-switching moon age plate step position SC1 when rotated in the current moon age plate rotation direction RR is 18, a post-switching direction step difference SDC between the current moon age plate step position SR and the second post-switching moon age plate step position SC2 when rotated in the post-switching moon age plate rotation direction RC is 12, and the post-switching direction step difference SDC is smaller than the current direction step difference SDR as the step rotation driving of the moon age plate 42.

When the current direction step difference SDR, which is a rotation angle of the moon age plate 42 in a case where the moon age plate 42 is rotated in the current moon age plate rotation direction RR from the current moon age plate step position SR corresponding to the current moon age plate rotation position to the post-switching moon age plate step position SC corresponding to the post-switching moon age plate rotation position, is less than a predetermined number of steps SDT corresponding to a predetermined rotation angle, the control circuit 72 rotates the moon age plate 42 in the current moon age plate rotation direction RR to rotationally drive in a step manner the moon age plate 42 from the current moon age plate step position SR to the post-switching moon age plate step position SC, and, when the current direction step difference SDR is equal to or more than the predetermined number of steps SDT, the control circuit 72 rotates the moon age plate 42 in the post-switching moon age plate rotation direction RC to rotationally drive in a step manner the moon age plate 42 from the current moon age plate step position SR to the post-switching moon age plate step position SC. Here, the predetermined number of steps SDT corresponding to the predetermined rotation angle is set based on at least one of a difference (|SDR−SDC|) between the current direction step difference SDR corresponding to the current direction rotation angle and the post-switching direction step difference SDC corresponding to the post-switching rotation angle that is the rotation angle of the moon age plate 42 when the moon age plate 42 is rotated in the post-switching moon age plate rotation direction RC from the current moon age plate step position SR corresponding to the current moon age plate rotation position to the post-switching moon age plate step position SC corresponding to the post-switching moon age plate rotation position, and the power consumption of the electronic watch 1 at the time of switching the moon age plate rotation direction R. The predetermined number of steps SDT in the present embodiment is set based on both of the difference (|SDR−SDC|) between the current direction step difference SDR and the post-switching direction step difference SDC, and the power consumption of the electronic watch 1 at the time of switching the moon age plate rotation direction R, and is set to 22. The power consumption of the electronic watch 1 decreases as the number of steps decreases in a case where the moon age plate 42 rotationally driven in a step manner in a plurality of steps in the same direction of the moon age plate rotation direction R. In addition, as the power consumption of the electronic watch 1, the power consumption in a case where the moon age plate 42 is rotationally driven one step in the post-switching moon age plate rotation direction RC may be larger than the power consumption in a case where the moon age plate 42 is rotationally driven one step in the current moon age plate rotation direction RR. Therefore, even when the post-switching direction step difference SDC is smaller than the current direction step difference SDR, the power consumption in the indication mode switching operation may be larger when the moon age plate rotation direction R is switched and the moon age plate 42 is rotationally driven in a step manner by the post-switching direction step difference SDC in consideration of the difference in power consumption in the moon age plate rotation direction R. Thus, in the electronic watch 1 of the present embodiment, the predetermined number of steps SDT is set based on both of the difference (|SDR−SDC|) between the current direction step difference SDR and the post-switching direction step difference SDC, and the difference in power consumption of the electronic watch 1 in the moon age plate rotation direction R, so that power consumption can be suppressed.

The actuator 73 rotationally drives the pointer 31, the date plate 34, the moon age plate 42, and the function hand 51. The actuator 73 includes a drive circuit, a drive portion, and the like, a control signal from the control circuit 72 is input to the drive circuit, a drive signal based on the input control signal is output to the drive portion, and the drive portion is driven based on the input drive signal. The actuator 73 in the present embodiment is a motor capable of performing step rotation driving such as a stepping motor or an electric motor, and includes a first actuator 73a that rotationally drives the second hand 31a, a second actuator 73b that rotationally drives the minute hand 31b and the hour hand 31c, the third actuator 73c that is an actuator for the moon age plate that rotationally drives the moon age plate 42, and the fourth actuator 73d that rotationally drives the function hand 51 and the date plate 34.

The gear train mechanism 74 transmits the driving force output from the actuator 73 to the pointer 31, the date plate 34, the moon age plate 42, and the function hand 51. The gear train mechanism 74 includes a gear train and the like, and has one end coupled to the actuator 73 and the other end coupled to the pointer 31, the date plate 34, the moon age plate 42, and the function hand 51. The gear train mechanism 74 in the present embodiment includes a first gear train mechanism 74a that couples the first actuator 73a and the second hand 31a, a second gear train mechanism 74b that couples the second actuator 73b, the minute hand 31b, and the hour hand 31c, a third gear train mechanism 74c that couples the third actuator 73c and the moon age plate 42, and a fourth gear train mechanism 74d that couples the fourth actuator 73d, the function hand 51, and the date plate 34.

The power generation mechanism 75 generates power using external energy, and supplies the generated power to electronic components such as the secondary battery 76 and the control circuit 72. As the power generation mechanism 75, a photoelectric conversion element that converts light energy, a thermoelectric conversion element that converts thermal energy, a mechanical electric conversion element that generates power from mechanical motion such as vibration energy, or the like can be used.

The secondary battery 76 is a power source that can store power generated by the power generation mechanism 75 and supplies the power to the control circuit 72, the actuator 73, other electronic components, and the like. As the secondary battery 76, for example, a lithium ion battery, an all-solid battery, or the like can be used.

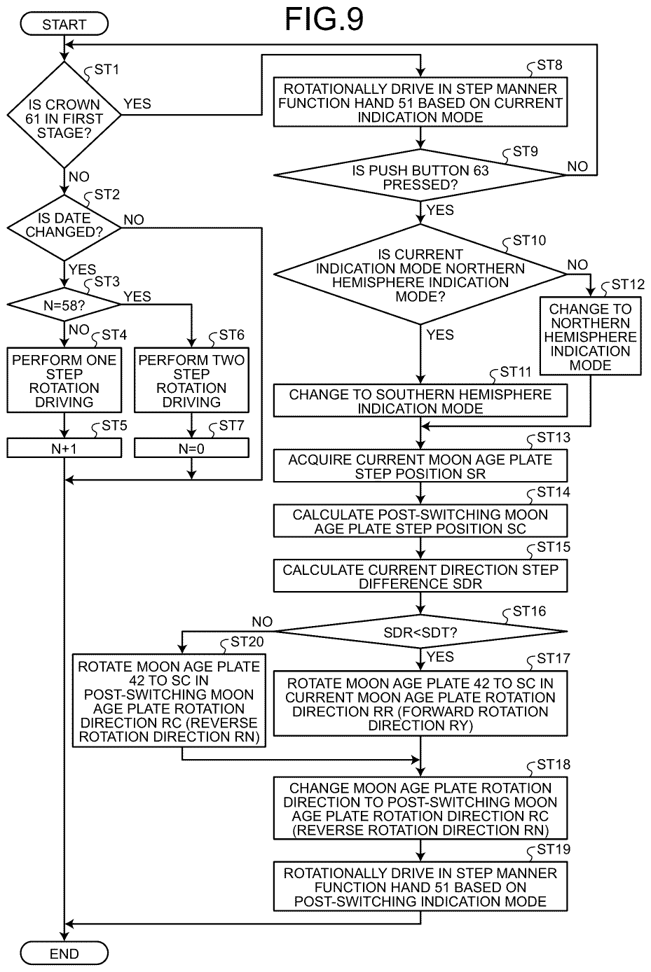

Next, the indication mode switching operation by the electronic watch 1 will be described. FIG. 9 is a flowchart of the indication mode switching operation of the electronic watch according to an embodiment. Note that the indication mode switching operation of the electronic watch 1 in the present embodiment will be described including a step rotation driving operation of the moon age plate 42. First, the control circuit 72 determines whether the crown 61 is in the first-stage position (Step ST1). Here, the control circuit 72 determines whether the user has an intention to operate the operation portion 6 in order to perform the indication mode switching operation or confirm the indication mode D.

Next, when determining that the crown 61 is not in the first-stage position (Step ST1: NO), the control circuit 72 determines whether the date has been changed (Step ST2). Here, the control circuit 72 determines whether or not to perform step rotation driving of the moon age plate 42 by determining whether or not the date information is counted up by one count based on the internal time.

Next, when determining that the date is to be changed (Step ST2: Yes), the control circuit 72 determines whether the count N of the moon age plate 42 is 58 (Step ST3). Here, the control circuit 72 determines whether or not the moon age plate 42 has been rotationally driven in a step manner up to two steps before within the 60 steps (60 days) of one turn, that is, 58 steps. Note that when determining that the date has not changed (Step ST2: No), the control circuit 72 ends this control cycle and transitions to the next control cycle.

Next, when determining that the count N of the moon age plate 42 is not 58 (Step ST3: No), the control circuit 72 rotationally drives the moon age plate 42 one step (Step ST4).

Next, the control circuit 72 counts up the count N of the moon age plate 42 one count (Step ST5), ends this control cycle, and transitions to the next control cycle.

In addition, when determining that the count N of the moon age plate 42 is 58 (Step ST3: Yes), the control circuit 72 rotationally drives the moon age plate 42 two steps (Step ST6).

Next, the control circuit 72 sets the count N of the moon age plate 42 to 0, that is, resets the count N (Step ST7), ends this control cycle, and transitions to the next control cycle. That is, the control circuit 72 performs the rotation driving of two steps once during one rotation of moon age plate 42.

In addition, when determining that the crown 61 is in the first-stage position (Step ST1: Yes), the control circuit 72 rotationally drives in a step manner the function hand 51 based on the current indication mode DR (Step ST8).

Next, the control circuit 72 determines whether the push button 63 has been pressed (Step ST9). Here, the control circuit 72 determines whether the user has an intention to perform the indication mode switching operation.

Next, when determining that the push button 63 has been pressed (Step ST9: Yes), the control circuit 72 determines whether the current indication mode DR is the Northern Hemisphere indication mode DN (Step ST10). Note that when determining that the push button 63 has not been pressed (Step ST9: No), the control circuit 72 repeats the determination as to whether the crown 61 is in the first-stage position, that is, Step ST1.

Next, when determining that the current indication mode DR is the Northern Hemisphere indication mode DN (Step ST10: Yes), the control circuit 72 changes the indication mode D from the Northern Hemisphere indication mode DN to the Southern Hemisphere indication mode DS, and sets the post-switching indication mode DC to the Southern Hemisphere indication mode DS (Step ST11).

In addition, when determining that the current indication mode DR is not the Northern Hemisphere indication mode DN (Step ST10: No), the control circuit 72 changes the indication mode D from the Southern Hemisphere indication mode DS to the Northern Hemisphere indication mode DN, and sets the post-switching indication mode DC to the Northern Hemisphere indication mode DN (Step ST12).

Next, the control circuit 72 acquires the current moon age plate step position SR (Step ST13).

Next, the control circuit 72 calculates the post-switching moon age plate step position SC based on the current moon age plate step position SR (Step ST14). Here, the control circuit 72 calculates the first post-switching moon age plate step position SC1 in the current moon age plate rotation direction RR with respect to the current moon age plate step position SR.

Next, the control circuit 72 calculates the current direction step difference SDR based on the current moon age plate step position SR and the first post-switching moon age plate step position SC1 (Step ST15).

Next, the control circuit 72 determines whether the current direction step difference SDR is less than the predetermined number of steps SDT (Step ST16). Here, the control circuit 72 determines whether the power consumption of the electronic watch 1 can be suppressed by rotationally driving in a step manner the moon age plate 42 in either the current moon age plate rotation direction RR or the post-switching moon age plate rotation direction RC to the post-switching moon age plate step position SC.

Next, when determining that the current direction step difference SDR is less than the predetermined number of steps SDT (Step ST16: Yes), the control circuit 72 rotationally drives in a step manner the moon age plate 42 to the post-switching moon age plate step position SC, that is, the first post-switching moon age plate step position SC1 in the current moon age plate rotation direction RR (Step ST17). For example, in a case where the indication mode before the indication mode switching operation is the Northern Hemisphere indication mode DN and SDT=22 (predetermined rotation angle of 132 degrees), when the switching operation is performed at the current moon age MR=10, the current direction step difference SDR=10 and the predetermined number of steps SDT=less than 22, and therefore, step rotation driving is performed in the current moon age plate rotation direction RR to the first post-switching moon age plate step position SC1.

In addition, when determining that the current direction step difference SDR is equal to or greater than the predetermined number of steps SDT (Step ST16: No), the control circuit 72 rotationally drives in a step manner the moon age plate 42 to the post-switching moon age plate step position SC, that is, the second post-switching moon age plate step position SC2 in the post-switching moon age plate rotation direction RC (Step ST20). For example, in a case where the indication mode before the indication mode switching operation is the Northern Hemisphere indication mode DN and SDT=22 (predetermined rotation angle of 132 degrees), when the switching operation is performed at the current moon age MR=3, the current direction step difference SDR=24 and the predetermined number of steps SDT=equal to or greater than 22, and therefore, step rotation driving is performed in the post-switching moon age plate rotation direction RC to the second post-switching moon age plate step position SC2.

Next, the control circuit 72 changes the moon age plate rotation direction R to the post-switching moon age plate rotation direction RC (Step ST18). Here, the control circuit 72 changes the current indication mode DR to the post-switching indication mode DC.

Next, the control circuit 72 rotationally drives in a step manner the function hand 51 based on the post-switching indication mode DC (Step ST19), ends this control cycle, and transitions to the next control cycle. Note that the step rotation driving (Step ST19) of the function hand 51 based on the post-switching indication mode DC in the present embodiment is performed after the moon age plate rotation direction R is changed to the post-switching moon age plate rotation direction RC (Step ST18), but it is not limited thereto, and the step rotation driving may be performed after it is determined that the push button 63 is pressed (Step ST9: Yes) until the current moon age plate step position SR is acquired (Step ST13), that is, immediately after the switching of the indication mode D.

As described above, in the electronic watch 1 in the present embodiment, the moon age plate 42 is rotationally driven in a step manner with the third actuator 73c to the post-switching moon age plate step position SC corresponding to the post-switching moon age plate rotation position corresponding to the post-switching moon age MC, which is separated on the opposite side to the current moon age side from the reference moon age MB by the reference moon age difference MD, and therefore, the arithmetic load of the control circuit 72 in the switching operation of the indication mode of the moon phase indication portion 4 can be suppressed as compared with the case of calculating the post-switching hemisphere moon age based on the internal time and rotationally driving the moon age plate to the post-switching moon age plate rotation position corresponding to the calculated post-switching hemisphere moon age.

In addition, in the electronic watch 1 in the present embodiment, since the moon age plate 42 makes one rotation in 60 steps, the control circuit 72 rotationally drives the moon age plate 42 one step per day, and rotationally drives in a step manner the moon age plate 42 two steps per day once every 59 days, the moon age plate 42 is rotationally driven for the two synodic periods in 59 days, the one synodic period is 29.5 days, and the one synodic period approaches an actual average synodic period 29.530589 of the month as compared with a case where the one synodic period is 30 days. Accordingly, even if the one synodic period in the moon age plate 42 is 30 days, the one synodic period can be close to the average synodic period 29.530589, and the error of the moon phase indication with the actual moon phase of the month can be reduced.

Note that when the current direction step difference SDR, which is a rotation angle of the moon age plate 42 in a case where the moon age plate 42 is rotated in the current moon age plate rotation direction RR from the current moon age plate step position SR to the post-switching moon age plate step position SC corresponding to the post-switching moon age plate rotation position, is less than the predetermined number of steps SDT corresponding to a predetermined rotation angle, the control circuit 72 in the present embodiment rotates the moon age plate 42 in the current moon age plate rotation direction RR, and, when the current direction step difference SDR is equal to or more than the predetermined number of steps SDT, the control circuit 72 rotates the moon age plate 42 in the post-switching moon age plate rotation direction RC, but it is not limited thereto. When a forward rotation direction step difference SDY, which is a rotation angle of the moon age plate 42 in a case where the moon age plate 42 is rotated in the forward rotation direction RY from the current moon age plate step position SR to the post-switching moon age plate step position SC corresponding to the post-switching moon age plate rotation position, is less than the predetermined number of steps SDT corresponding to a predetermined rotation angle, the control circuit 72 may rotate the moon age plate 42 in the forward rotation direction RY, and, when the forward rotation direction step difference SDY is equal to or more than the predetermined number of steps SDT, the control circuit 72 may rotate the moon age plate 42 in the reverse rotation direction RN. In this case, the predetermined number of steps SDT, which is the predetermined rotation angle, may be set based on a difference between the forward rotation direction step difference SDY, which is the forward rotation direction rotation angle, and a reverse rotation direction step difference SDN, which is a rotation angle of the moon age plate when the moon age plate 42 is rotated in the reverse rotation direction RN from the current moon age plate step position SR to the post-switching moon age plate step position SC, and a difference in power consumption in the moon age plate rotation direction R. Normally, as the power consumption of the electronic watch 1, the power consumption in a case where the moon age plate 42 is rotationally driven one step in the reverse rotation direction RN is larger than the power consumption in a case where the moon age plate 42 is rotationally driven one step in the forward rotation direction RY, and therefore, the predetermined number of steps SDT is set based on both the difference (|SDY−SDN|) between the forward rotation direction step difference SDY and the reverse rotation direction step difference SDN and the difference in power consumption of the electronic watch 1 in the moon age plate rotation direction R (forward rotation direction RY and reverse rotation direction RN), and therefore, the power consumption can be suppressed.

In addition, the predetermined number of steps SDT in the present embodiment is a constant value, but is not limited thereto, and may be varied based on the current indication mode DR. For example, the predetermined number of steps SDT may be different between a value when the current indication mode DR is the Northern Hemisphere indication mode DN and a value when the current indication mode DR is the Southern Hemisphere indication mode DS.

In addition, in the present embodiment, the moon marks 421 and 422 are the same, but it is not limited thereto, and the moon marks 421 and 422 may be different from each other. FIG. 10 is a diagram illustrating an example of operation explanation of the moon phase indication portion at the time of the indication mode switching operation according to a modification, and is an example in which the current moon age plate rotation position and the post-switching moon age plate rotation position are indicated with the same moon mark. FIG. 11 is a diagram illustrating an example of operation explanation of the moon phase indication portion at the time of the indication mode switching operation according to a modification, and is an example in which the current moon age plate rotation position and the post-switching moon age plate rotation position are indicated with different moon marks.

As illustrated in FIGS. 10 and 11, for example, the moon marks 421 and 422 may have different colors so that the user can distinguish the moon marks 421 and 422 by visually recognizing them. In this case, the post-switching moon age plate step position SC corresponding to the post-switching moon age MC (=24) with respect to the current moon age MR (=6) corresponding to the current moon age plate step position SR (=6, the moon phase indication is performed with the moon mark 421) includes the first post-switching moon age plate step position SC1 (=24, the moon phase indication is performed with the moon mark 421) as illustrated in FIG. 10 and the second post-switching moon age plate step position SC2 (=54, the moon phase indication is performed with the moon mark 422) as illustrated in FIG. 11. In a case where the moon marks 421 and 422 are different from each other, even when the moon age plate 42 is rotationally driven from the current moon age plate step position SR (=6) to the first post-switching moon age plate step position SC1 (=24), the moon mark used for the moon phase indication is the moon mark 421 used for the same synodic period, so that the user visually recognizing the moon phase indication portion 4 does not feel strange. On the other hand, when the moon age plate 42 is rotationally driven from the current moon age plate step position SR (=6) to the second post-switching moon age plate step position SC2 (=54), the moon mark used for the moon phase indication becomes the moon mark 422 used for the synodic period different from the synodic period before the switching operation from the moon mark 421, so that the user visually recognizing the moon phase indication portion 4 feels strange.

When determining that the switching operation of the indication mode is performed by the operation portion 6, the control circuit 72 rotationally drives the moon age plate 42 from the current moon age plate step position SR to the post-switching moon age plate step positions SC1 and SC2, which are the post-switching moon age plate rotation positions corresponding to the moon marks 421 and 422 that perform the moon phase indication of the synodic period at the current moon age MR, out of the first post-switching moon age plate step position SC1 and the second post-switching moon age plate step position SC2, so that it is possible to suppress for the user visually recognizing the moon phase indication portion 4 to feel strange.

Specifically, when the indication mode is the Northern Hemisphere indication mode DN and the current moon age MR based on the current moon age plate step position SR is less than the reference moon age MB (MR<MB), the control circuit 72 performs rotation driving in the forward rotation direction RY from the current moon age plate step position SR to the post-switching moon age plate step position SC. In addition, when the indication mode is the Northern Hemisphere indication mode DN and the current moon age MR based on the current moon age plate step position SR exceeds the reference moon age MB (MR>MB), the control circuit 72 performs rotation driving in the reverse rotation direction RN from the current moon age plate step position SR to the post-switching moon age plate step position SC.

In addition, when the indication mode is the Southern Hemisphere indication mode DS and the current moon age MR based on the current moon age plate step position SR is less than the reference moon age MB (MR<MB), the control circuit 72 performs rotation driving in the reverse rotation direction RN from the current moon age plate step position SR to the post-switching moon age plate step position SC. In addition, when the indication mode is the Southern Hemisphere indication mode DS and the current moon age MR based on the current moon age plate step position SR exceeds the reference moon age MB (MR>MB), the control circuit 72 performs rotation driving in the forward rotation direction RY from the current moon age plate step position SR to the post-switching moon age plate step position SC.

In addition, in the present embodiment, the moon age plate 42 is rotationally driven in a step manner one step per day, but the present embodiment is not limited thereto, and the moon age plate 42 may be rotationally driven in a step manner n steps per day (n>1). In this case, in a case where the moon age plate 42 makes one rotation in 60 steps by being rotationally driven in a step manner one step per day, the moon age plate 42 makes one rotation in 60×n steps by being rotationally driven in a step manner n steps per day.

In addition, in the present embodiment, the moon phase indication corresponding to the moon age of the synodic period of the two synodic periods is performed by one rotation of the moon age plate 42, but it is not limited thereto, and the moon phase indication corresponding to the moon age of the synodic period of one synodic period may be performed by one rotation of the moon age plate 42. In this case, the post-switching moon age plate step position SC is the number of the synodic periods, that is, one.

In addition, in the present embodiment, the control circuit 72 rotationally drives the moon age plate 42 one step per day and rotationally drives in a step manner the moon age plate 42 two steps per day once every 59 days, but it is not limited thereto, and the moon age plate 42 may be rotationally driven in a step manner two steps per day once every two months based on the internal time. In addition, in the present embodiment, the moon age plate 42 makes one rotation in 60 steps, but it is not limited thereto, and it is sufficient if the moon age plate 42 makes one rotation in an even number of steps, and the moon age plate 42 may make one rotation in 58 steps, for example. In this case, when determining that the count N of the moon age plate 42 is 58, the control circuit 72 performs rotation driving of one step and does not set the count N of the moon age plate 42 to 0, and when further determining that the date is to be changed, the control circuit 72 does not perform rotation driving of one step and sets the count N of the moon age plate 42 to 0. In addition, the moon age plate 42 may make one rotation in an odd number of steps, and for example, the moon age plate 42 may make one rotation in 59 steps. In this case, the reference moon age MB is set to 14.5.

In addition, in the present embodiment, the current moon age plate step position SR of the moon age plate 42 is manually set by the user, but it is not limited thereto, and the control circuit 72 may correct the current moon age plate step position SR based on the received time information (including western calendar, month information, and date information). Specifically, the control circuit obtains the position by (the number of days X from the reference date+the moon age Y of the reference date) % 29.53=corrected moon age W. For example, if X is 1593 and Y is 14.7, W is 13.

### REFERENCE SIGNS LIST

1 ELECTRONIC WATCH
2 EXTERIOR CASE
21 BODY
22 BEZEL
23 WINDSHIELD
24 END PIECE
3 TIME INDICATION PORTION
31 POINTER
32 DIAL PLATE
321, 322 HOUR MARK
323 DATE PLATE OPENING
33 DIAL TRIM RING
34 DATE PLATE
341 DATE MARK
4 MOON PHASE INDICATION PORTION
41 MOON AGE PLATE OPENING
421, 422 RECESS
42 MOON AGE PLATE
421, 422 MOON MARK
43, 44 MOON AGE PLATE ROTATION DIRECTION MARK
5 FUNCTION INDICATION PORTION
51 FUNCTION HAND
52 FUNCTION MARK PLATE
6 OPERATION PORTION
61 CROWN
62, 63 PUSH BUTTON
7 MOVEMENT
71 ANTENNA
72 CONTROL CIRCUIT
73 ACTUATOR
73a FIRST ACTUATOR
73b SECOND ACTUATOR
73c THIRD ACTUATOR (ACTUATOR FOR MOON AGE PLATE)
73d FOURTH ACTUATOR
74 GEAR TRAIN MECHANISM
74a FIRST GEAR TRAIN MECHANISM
74b SECOND GEAR TRAIN MECHANISM
74c THIRD GEAR TRAIN MECHANISM
74d FOURTH GEAR TRAIN MECHANISM
75 POWER GENERATION MECHANISM
76 SECONDARY BATTERY
8 BELT
O1 WATCH CENTER
O2 MOON AGE PLATE CENTER
O3 FUNCTION MARK CENTER

1-8. (canceled)

9. An electronic watch comprising:
a time indication portion that performs time indication based on an internal time;
a moon phase indication portion that includes at least a moon age plate rotatably supported and performs moon phase indication corresponding to a moon age by rotation of the moon age plate;
an actuator for the moon age plate that rotationally drives the moon age plate;
a control circuit that controls a moon age plate rotation direction that is a rotation direction of the moon age plate and a moon age plate rotation position that is a rotation position of the moon age plate with the actuator for the moon age plate; and
an operation portion that at least switches an indication mode of the moon phase indication portion to one of a Northern Hemisphere indication mode that indicates a moon phase in a Northern Hemisphere and a Southern Hemisphere indication mode that indicates a moon phase in a Southern Hemisphere, wherein
the control circuit
when it is determined that an operation of switching the indication mode is performed by the operation portion,
when a moon age difference of a current moon age based on a current moon age plate rotation position with respect to a reference moon age is defined as a reference moon age difference, rotationally drives the moon age plate with the actuator for the moon age plate from the current moon age plate rotation position to a post-switching moon age plate rotation position separated by the reference moon age difference on an opposite side to a current moon age side from the reference moon age, and sets the moon age plate rotation direction to a post-switching moon age plate rotation direction that is an opposite direction to a current moon age plate rotation direction.

10. The electronic watch according to claim 9, wherein
the control circuit
when a current direction rotation angle that is a rotation angle of the moon age plate when the moon age plate is rotated in the current moon age plate rotation direction from the current moon age plate rotation position to the post-switching moon age plate rotation position is equal to or greater than a predetermined rotation angle, rotates the moon age plate in the post-switching moon age plate rotation direction, and
rotates the moon age plate from the current moon age plate rotation position to the post-switching moon age plate rotation position.

11. The electronic watch according to claim 10, wherein
the predetermined rotation angle is
set based on at least one of a difference between the current direction rotation angle and a post-switching rotation angle that is a rotation angle of the moon age plate when the moon age plate is rotated in the post-switching moon age plate rotation direction from the current moon age plate rotation position to the post-switching moon age plate rotation position, and a power consumption difference depending on the moon age plate rotation direction.

12. The electronic watch according to claim 9, wherein
the control circuit
when a forward rotation direction rotation angle that is a rotation angle of the moon age plate when the moon age plate is rotated in a forward rotation direction of the actuator for the moon age plate from the current moon age plate rotation position to the post-switching moon age plate rotation position is equal to or greater than a predetermined rotation angle, rotates the moon age plate in a reverse rotation direction that is an opposite direction to the forward rotation direction, and
rotates the moon age plate from the current moon age plate rotation position to the post-switching moon age plate rotation position.

13. The electronic watch according to claim 12, wherein
the predetermined rotation angle is
set based on at least one of a difference between the forward rotation direction rotation angle and a reverse rotation direction rotation angle that is a rotation angle of the moon age plate when the moon age plate is rotated in the reverse rotation direction from the current moon age plate rotation position to the post-switching moon age plate rotation position, and a difference in power consumption depending on the moon age plate rotation direction.

14. The electronic watch according to claim 9, wherein
the moon phase indication portion performs moon phase indication corresponding to a moon age of a synodic period of two or more synodic periods in one rotation of the moon age plate, and
the post-switching moon age plate rotation position is a first post-switching moon age plate rotation position that is the post-switching moon age plate rotation position in the current moon age plate rotation direction with respect to the current moon age plate rotation position, and a second post-switching moon age plate rotation position that is the post-switching moon age plate rotation position in the post-switching moon age plate rotation direction with respect to the current moon age plate rotation position.

15. The electronic watch according to claim 10, wherein
the moon phase indication portion performs moon phase indication corresponding to a moon age of a synodic period of two or more synodic periods in one rotation of the moon age plate, and
the post-switching moon age plate rotation position is a first post-switching moon age plate rotation position that is the post-switching moon age plate rotation position in the current moon age plate rotation direction with respect to the current moon age plate rotation position, and a second post-switching moon age plate rotation position that is the post-switching moon age plate rotation position in the post-switching moon age plate rotation direction with respect to the current moon age plate rotation position.

16. The electronic watch according to claim 11, wherein
the moon phase indication portion performs moon phase indication corresponding to a moon age of a synodic period of two or more synodic periods in one rotation of the moon age plate, and
the post-switching moon age plate rotation position is a first post-switching moon age plate rotation position that is the post-switching moon age plate rotation position in the current moon age plate rotation direction with respect to the current moon age plate rotation position, and a second post-switching moon age plate rotation position that is the post-switching moon age plate rotation position in the post-switching moon age plate rotation direction with respect to the current moon age plate rotation position.

17. The electronic watch according to claim 12, wherein
the moon phase indication portion performs moon phase indication corresponding to a moon age of a synodic period of two or more synodic periods in one rotation of the moon age plate, and
the post-switching moon age plate rotation position is a first post-switching moon age plate rotation position that is the post-switching moon age plate rotation position in the current moon age plate rotation direction with respect to the current moon age plate rotation position, and a second post-switching moon age plate rotation position that is the post-switching moon age plate rotation position in the post-switching moon age plate rotation direction with respect to the current moon age plate rotation position.

18. The electronic watch according to claim 13, wherein
the moon phase indication portion performs moon phase indication corresponding to a moon age of a synodic period of two or more synodic periods in one rotation of the moon age plate, and
the post-switching moon age plate rotation position is a first post-switching moon age plate rotation position that is the post-switching moon age plate rotation position in the current moon age plate rotation direction with respect to the current moon age plate rotation position, and a second post-switching moon age plate rotation position that is the post-switching moon age plate rotation position in the post-switching moon age plate rotation direction with respect to the current moon age plate rotation position.

19. The electronic watch according to claim 14, wherein
the actuator for the moon age plate rotationally drives in a step manner the moon age plate,
the moon phase indication portion performs moon phase indication corresponding to a moon age of a synodic period of two synodic periods in one rotation of the moon age plate,
the moon age plate makes one rotation in 60 steps, and
the control circuit
rotationally drives the moon age plate one step per day with the actuator for the moon age plate, and
performs step rotation driving with the actuator for the moon age plate two steps per day once every 59 days or once every 2 months.

20. The electronic watch according to claim 15, wherein
the actuator for the moon age plate rotationally drives in a step manner the moon age plate,
the moon phase indication portion performs moon phase indication corresponding to a moon age of a synodic period of two synodic periods in one rotation of the moon age plate,
the moon age plate makes one rotation in 60 steps, and
the control circuit
rotationally drives the moon age plate one step per day with the actuator for the moon age plate, and
performs step rotation driving with the actuator for the moon age plate two steps per day once every 59 days or once every 2 months.

21. The electronic watch according to claim 16, wherein
the actuator for the moon age plate rotationally drives in a step manner the moon age plate,
the moon phase indication portion performs moon phase indication corresponding to a moon age of a synodic period of two synodic periods in one rotation of the moon age plate,
the moon age plate makes one rotation in 60 steps, and
the control circuit
rotationally drives the moon age plate one step per day with the actuator for the moon age plate, and
performs step rotation driving with the actuator for the moon age plate two steps per day once every 59 days or once every 2 months.

22. The electronic watch according to claim 17, wherein
the actuator for the moon age plate rotationally drives in a step manner the moon age plate,
the moon phase indication portion performs moon phase indication corresponding to a moon age of a synodic period of two synodic periods in one rotation of the moon age plate,
the moon age plate makes one rotation in 60 steps, and
the control circuit
rotationally drives the moon age plate one step per day with the actuator for the moon age plate, and
performs step rotation driving with the actuator for the moon age plate two steps per day once every 59 days or once every 2 months.

23. The electronic watch according to claim 18, wherein
the actuator for the moon age plate rotationally drives in a step manner the moon age plate,
the moon phase indication portion performs moon phase indication corresponding to a moon age of a synodic period of two synodic periods in one rotation of the moon age plate,
the moon age plate makes one rotation in 60 steps, and
the control circuit
rotationally drives the moon age plate one step per day with the actuator for the moon age plate, and
performs step rotation driving with the actuator for the moon age plate two steps per day once every 59 days or once every 2 months.

24. The electronic watch according to claim 9, wherein
the moon phase indication portion performs moon phase indication corresponding to a moon age of a synodic period of two synodic periods in one rotation of the moon age plate, and two moon marks formed on the moon age plate are different from each other,
the post-switching moon age plate rotation position is a first post-switching moon age plate rotation position that is the post-switching moon age plate rotation position in the current moon age plate rotation direction with respect to the current moon age plate rotation position, and a second post-switching moon age plate rotation position that is the post-switching moon age plate rotation position in the post-switching moon age plate rotation direction with respect to the current moon age plate rotation position, and
the control circuit
when it is determined that the operation of switching the indication mode is performed by the operation portion,
rotationally drives the moon age plate from the current moon age plate rotation position with the actuator for the moon age plate to the post-switching moon age plate rotation position corresponding to the moon mark for performing the moon phase indication of the synodic period at the current moon age out of the two post-switching moon age plate rotation positions.
